(19) United States
(12) Patent Application Publication
(10) Pub. No.: US 2025/0264927 A1
(43) Pub. Date: Aug. 21, 2025

(54) INTERCONNECT DEVICE POWER PROFILING

(71) Applicant: MELLANOX TECHNOLOGIES, LTD., Yokneam (IL)

(72) Inventors: Niv Aibester, Herzliya (IL); Amit Kazimirsky, Givat-Shmuel (IL); Avi Shalom, Tel Aviv (IL); Shmuel Roi Shichrur, Tel Aviv (IL); Nir Sucher, Ramat Hashofet (IL)

(21) Appl. No.: 18/581,839

(22) Filed: Feb. 20, 2024

(51) Int. Cl. G06F 1/3206; G06F 1/3234; H04L 43/16

(52) U.S. Cl. CPC G06F 1/3206; G06F 1/3234; H04L 43/16

(57) ABSTRACT

An interconnect device is provided. In one example, an interconnect device includes ports and a power profile controller to receive a power profile, monitor one or more of data traversing the switch and power consumption of the switch, and during a first time period determine at least one of an ingress bandwidth exceeds a first bandwidth threshold and the power consumption exceeds a first power threshold. At least one of the first bandwidth threshold and the first power threshold is defined in the power profile. During the first time period, the power profile controller is to, in response to determining the at least one of the ingress bandwidth exceeds the first bandwidth threshold and the power consumption exceeds the first power threshold, limit one or more of the data traversing the switch and the power consumption of the interconnect device.

### FIELD OF THE DISCLOSURE

The present disclosure is generally directed toward networking and, in particular, toward networking devices and methods of operating the same.

### BACKGROUND

Switches and similar network devices represent a core component of many communication, security, and computing networks. Switches are often used to connect multiple devices, device types, networks, and network types.

Devices including but not limited to personal computers, servers, or other types of computing devices, may be interconnected using network devices such as switches. Such interconnected entities form a network that enables data communication and resource sharing among the nodes. While a particular switch may be capable of handling large amounts of data, often, switches do not operate at full capacity. As a result, conventional switches consume amounts of power which may be unnecessarily high during periods of low traffic.

### BRIEF SUMMARY

In accordance with one or more embodiments described herein, a computing system, such as an interconnect device, may enable a diverse range of systems, such as switches, servers, personal computers, and other computing devices, to communicate across a network. Such a computing system, which may be referred to herein as an interconnect device or switch, may implement one or more power profiles. Implementing a power profile may include monitoring ingress and/or egress bandwidth and/or power consumption and comparing the monitored bandwidth and/or power consumption to one or more thresholds based on the power profile. The thresholds may be used by the computing system to limit ingress and/or egress bandwidth based on the monitored bandwidth and/or power consumption and reducing an overall amount of power consumption when less than a maximum amount of bandwidth of data traversing the computing system is required by the power profile.

The present disclosure describes a system and method for enabling an interconnect device, such as a switch, or other computing system to reduce overall power consumption by offering client devices a feature in which the client devices may be enabled to adjust periods of high bandwidth (or high power consumption) followed by periods of low bandwidth (or low power consumption). Implementations described herein involve the throttling of bandwidth based on power profiles including one or more thresholds. In some examples, a power profile may include four thresholds, such as a low-bandwidth threshold, a mid-bandwidth threshold, a high-bandwidth threshold, and a maximum-bandwidth threshold. It should be appreciated that in some implementations a power profile may include any number of thresholds greater than or less than four thresholds. Processing devices which perform process-intensive tasks may operate in a manner in which the processing devices perform computational tasks for a period of time before sending data over one or more interconnect devices. During the period of time in which the processing devices perform process-intensive tasks, the interconnect devices may be little used or not used at all. On the other hand, during the period of time in which the processing devices send data over the one or more interconnect devices, the interconnect devices may be used at a high level or a maximum level. Because during normal operation interconnect devices used by processing devices are required for relatively short bursts during which the processing devices are not occupied with processing and are using the interconnect devices for interconnect services, the interconnect devices may be configured to offer periods of high bandwidth capability. During the periods when the interconnect services are less likely to be utilized by the processing devices, the interconnect devices may offer periods of low bandwidth capability.

Embodiments of the present disclosure aim to improve power efficiency and other issues by implementing a power profiling approach. The power profiling approach depicted and described herein may be applied to a switch, a router, or any other suitable type of networking device known or yet to be developed. In an illustrative example, a system is disclosed that includes one or more circuits to receive a power profile, monitor one or more of data traversing the system and power consumption of the system, and during a first time period: determine at least one of an ingress bandwidth exceeds a first bandwidth threshold and the power consumption exceeds a first power threshold, wherein at least one of the first bandwidth threshold and the first power threshold is defined in the power profile and in response to determining the at least one of the ingress bandwidth exceeds the first bandwidth threshold and the power consumption exceeds the first power threshold, limit one or more of the data traversing the system and the power consumption of the system.

In another example, a method is disclosed that includes receiving a power profile; monitoring one or more of data traversing a system and power consumption of the system; and during a first time period: determining at least one of an ingress bandwidth exceeds a first bandwidth threshold and the power consumption exceeds a first power threshold, wherein at least one of the first bandwidth threshold and the first power threshold is defined in the power profile; and in response to determining the at least one of the ingress bandwidth exceeds the first bandwidth threshold and the power consumption exceeds the first power threshold, limiting one or more of the data traversing the system and the power consumption of the system.

In yet another example, a switch is disclosed that includes one or more ports and a power profile controller to: receive a power profile; monitor one or more of data traversing the switch and power consumption of the switch; and during a first time period: determine at least one of an ingress bandwidth exceeds a first bandwidth threshold and the power consumption exceeds a first power threshold, wherein at least one of the first bandwidth threshold and the first power threshold is defined in the power profile; and in response to determining the at least one of the ingress bandwidth exceeds the first bandwidth threshold and the power consumption exceeds the first power threshold, limit one or more of the data traversing the switch and the power consumption of the switch.

Any of the above example aspects include wherein a power supply is shared by one or more switches and one or more processing devices, and a power profile involves the power supply providing greater amounts of power to the one or more processing devices and less power to the one or more switches for a first period of time followed by the power supply providing greater amounts of power to the one or more switches and less power to the one or more processing devices for a second period of time.

Any of the above example aspects include wherein monitoring the data traversing the system comprises monitoring one or more of a bandwidth, a packet rate, a buffer utilization, and a queue length.

Any of the above example aspects include wherein the one or more circuits are further to correlate the monitored data traversing the system with the power consumption of the system and to adjust one or more of the first power threshold and the first bandwidth threshold based on the correlation to account for leakage of power.

Any of the above example aspects include wherein the one or more circuits are further to update one or more of the first power threshold and the first bandwidth threshold based on a correlation of the monitored data traversing the system with the power consumption of the system.

Any of the above example aspects include wherein limiting the one or more of the data traversing the system and the power consumption of the system comprises limiting one or more of an ingress bandwidth and an egress bandwidth.

Any of the above example aspects include wherein the first power threshold indicates a user-defined power consumption limit and/or power consumption limits set by an optimization algorithm or artificial intelligence model.

Any of the above example aspects include wherein the system receives power from a power supply shared by one or more interconnect devices and processing devices, wherein the power consumption limit is associated with an amount of power consumed by the system from the power supply.

Any of the above example aspects include wherein the first bandwidth threshold indicates a user-defined bandwidth limit.

Any of the above example aspects include wherein the one or more circuits are further to determine a power requirement based on the bandwidth limit.

Any of the above example aspects include wherein the one or more circuits are further to measure one or more of a current and a voltage and calculate a moving average power consumption.

Any of the above example aspects include wherein the one or more circuits are further to, during a second time period, determine at least one of the ingress bandwidth exceeds a second bandwidth threshold and the power consumption exceeds a second power threshold, wherein at least one of the second bandwidth threshold and the second power threshold is defined in the power profile; and in response to determining the at least one of the ingress bandwidth exceeds the second bandwidth threshold and the power consumption exceeds the second power threshold, limit egress of packets.

Any of the above example aspects include wherein at least one of the first bandwidth threshold is greater than the second bandwidth threshold and the at least one of the first power threshold is greater than the second power threshold.

Any of the above example aspects include wherein the first time period is of a lesser duration than the second time period.

Any of the above example aspects include wherein a shaper circuit determines the at least one of the ingress bandwidth exceeds the first bandwidth threshold and the power consumption exceeds the first power threshold and determines the at least one of the ingress bandwidth exceeds the second bandwidth threshold and the power consumption exceeds the second power threshold.

Any of the above example aspects include wherein limiting egress of packets comprises one or more of throttling traffic and dropping packets. Implementations include wherein different thresholds and levels of throttling apply to particular queues such as low and high priority queues.

Any of the above example aspects include wherein the power profile specifies two or more time periods, wherein the first time period is associated with one or more of the first bandwidth threshold and the first power threshold and a second time period is associated with one or more of a second bandwidth threshold and a second power threshold.

Any of the above example aspects include wherein the one or more circuits are further to monitor a temperature and adjust one or more of the first bandwidth threshold and the first power threshold based on the temperature.

Any of the above example aspects include wherein the power profile is one of a plurality of power profiles and each of the plurality of power profiles is associated with a respective application, wherein the one or more circuits are further to aggregate the plurality of power profiles and determine one or more of the first bandwidth threshold and the first power threshold based on the aggregated plurality of power profiles.

Additional features and advantages are described herein and will be apparent from the following Detailed Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a network in accordance with at least some embodiments of the present disclosure;

FIG. 2 is a block diagram depicting an illustrative configuration of an interconnect device in accordance with at least some embodiments of the present disclosure;

FIG. 3 is a block diagram depicting an illustrative configuration of routing circuitry of an interconnect device in accordance with at least some embodiments of the present disclosure;

FIG. 4 is a graph depicting an illustrative power profile in accordance with at least some embodiments of the present disclosure; and

FIG. 5 is a flowchart depicting an illustrative configuration of a method in accordance with at least some embodiments of the present disclosure.

Like reference numbers and designations in the various drawings indicate like elements.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not to be deemed “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

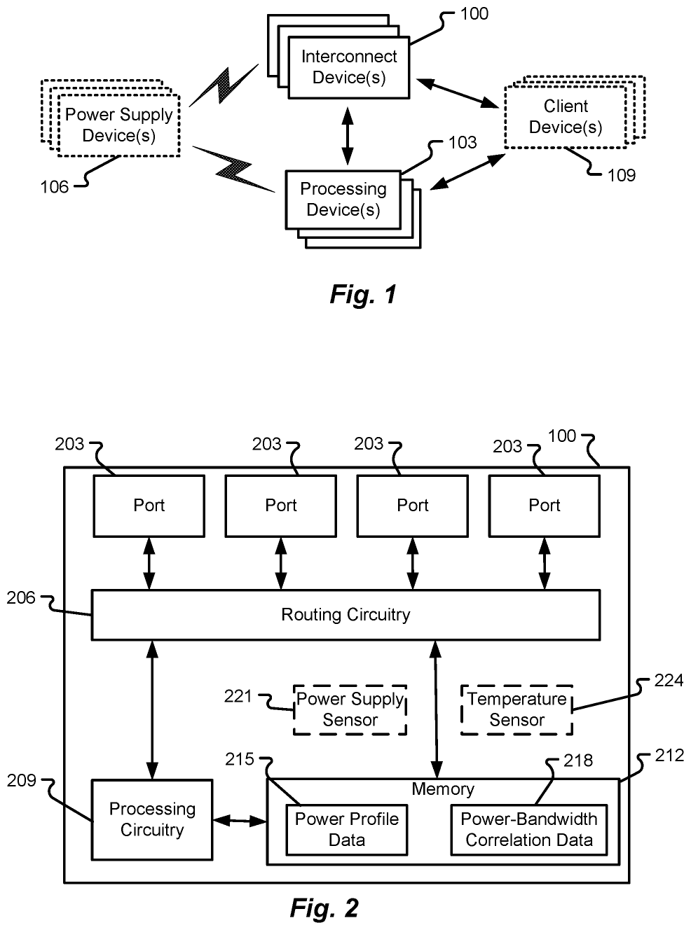

Referring now to FIGS. 1-5, various systems and methods for implementing a power profile in an interconnect device will be described. The concepts of power profiles depicted and described herein can be applied to any type of computing system capable of receiving and/or transmitting data, whether the computing system includes one port or a plurality of ports. Such a computing system may be a switch, but it should be appreciated any type of computing system may be used. The ability of interconnect devices, such as switches, to traverse data is constantly increasing, forwarding packet-processing is becoming more complex as a result power-requirements, and power-density of interconnect devices is increasing.

Since the purpose of an interconnect device may be on-demand packet-forwarding for incoming packets from clients and processing devices, the power envelope from the system side must always support the worst-power-requirements from the switch, which is a maximum power use-case occurring on most stress packet processing density and bandwidth. With power-profiling as described herein, a client can chart applicable power profile(s) that is applicable to one or more particular applications with windows of high bandwidth and of low or no bandwidth to reach an average power envelope.

As illustrated in FIG. 1, a computing environment as described herein may be a network of processing devices 103 interconnected by interconnect devices 100. One or more interconnect devices 100 may be in communication with one or more processing devices 103. The network of processing devices 103 and interconnect devices 100 may be in communication with one or more client devices 109. The processing devices 103 and interconnect devices 100 may be powered by one or more power supply devices 106. Such a network of processing devices 103 and interconnect devices 100 may be useful in various settings, from data centers and cloud computing infrastructures to artificial intelligence systems.

Processing devices 103 may be computing units, such as personal computers, servers, or other computing devices, and may be responsible for executing applications and performing data processing tasks. Processing devices 103 as described herein can range from servers in a data center to desktop computers in a network, or to devices such as internet of things (IoT) sensors and smart devices.

Each processing device 103 may include one or more processing circuits, such as Graphics Processing Units (GPUs), central processing units (CPUs), application-specific integrated circuits (ASICs), field programmable gate arrays (FPGAs), or other circuitry capable of performing computations, as well as memory and storage resources to run software applications, handle data processing, and perform specific tasks as required. In some implementations, processing devices 103 may also or alternatively include hardware such as GPUs for handling intensive tasks for machine learning, artificial intelligence (AI) workloads, or other complex processes.

For example, processing devices 103 may operate as a high-performance computing (HPC) cluster. A cluster of processing devices 103 may comprise numerous interconnected servers, each equipped with powerful CPUs and/or GPUs. The processing devices 103 may provide computational horsepower for, as an example, training large-scale AI models or running complex scientific simulations. For AI and machine learning tasks, the processing devices 103 may comprise one or more GPUs or other processing circuitry which may be capable of handling parallel processing requirements of neural networks and other applications.

Interconnect devices 100, as described in greater detail herein, may enable communication between processing devices 103 and/or client devices 109. An interconnect device 100 may be, for example, a switch, a network interface controller (NIC), or other device capable of receiving and sending data, and may act as a central node in the network. Interconnect devices 100 may be wired in a topology including spine switches and top-of-rack (TOR) switches for example. Interconnect devices 100 may be capable of receiving, processing, and forwarding data, e.g., packets, to appropriate destinations within the network, such as processing devices 103 and/or client devices 109. In some implementations, an interconnect device 100 may be included in a switch box, a platform, or a case which may contain one or more interconnect devices 100 as well as one or more power supply devices 106.

In some implementations, each processing device 103 may be connected to one or more ports of one or more interconnect devices 100 via network cables or wirelessly. Processes, such as applications, executed by processing devices 103 may involve transmitting data to nodes of the network, such as to other processing devices 103 and/or to client devices 109. Data may flow through the network of processing devices 103 and interconnect devices 100 using one or more protocols such as transmission control protocol (TCP), user datagram protocol (UDP), or Internet protocol (IP), for example. Each interconnect device 100 may, upon receiving data from a processing device 103 or another interconnect device 100, examine the data to identify a destination for the data and route the data through the network.

Each interconnect device 100 may receive power from a power supply device 106 shared by one or more interconnect devices 100 and/or processing devices 103, from a power supply device 106 contained within the interconnect device 100, or from a power supply device 106 dedicated to the interconnect device 100. A power supply device 106 may comprise a power regulator or other power supply circuitry. In some implementations, a power supply device 106 may supply power to a voltage regulator (VR) which may sustain power as required for a particular interconnect device 100. For example, a VR may sustain 600 watts, although applications executed by an interconnect device 100 may on average consume much less power.

Power supply devices 106 shared by interconnect devices 100 and processing devices 103 may be capable of dynamically redirecting power from interconnect devices to processing devices (and vice versa). For example, when processing devices 103 are performing computations, the processing devices 103 may require less interaction with interconnect devices 100. As a result, while the processing devices 103 may require a greater than average level of processing power, the interconnect devices 100 may require less than average or no power. On the other hand, when processing devices 103 are not performing computational processing, the processing devices 103 may rely on the interconnect devices 100. As a result, while the interconnect devices 100 may require a greater than average level of processing power, the processing devices 103 may require less than average or no power.

When an interconnect device 100 is not actively being used by a processing device 103 to transmit data, the interconnect 100 may enter a standby or low-power mode. During such times, the interconnect device 100, while not consuming more than an average amount of power, may be capable of receiving, processing, and forwarding a packet when needed. As such, the power supply device 106 may supply interconnect devices 100 sufficient power to meet demands of processing devices 103. The power supply device(s) 106 may be capable of supporting both the interconnect devices 100 and the processing devices 103 with sufficient power to accomplish necessary tasks at the proper times.

Client devices 109 as described herein may be computing devices which, for example, engage in AI-related, research-related, and other processor-intensive tasks, and utilize processing devices 103 to handle the computational loads and data throughput required by such intensive applications. Client devices 109 may include, for example, workstations and personal computers used by researchers, data scientists, and professionals for developing, testing, and running AI models and research simulations. Client devices 109 may include one or more CPUs and/or GPUs but may require additional computational power for complex tasks.

By interacting with processing devices 103, client devices 109 may be enabled to perform functions such as training machine learning models, performing data processing, running simulations, analyzing large datasets, and performing complex data processing tasks, such as data mining, pattern recognition, and predictive modeling, for examples.

An interconnect device 100 as described herein may in some implementations be as illustrated in FIG. 2. Such an interconnect device 100 may include a plurality of ports 203, routing circuitry 206, processing circuitry 209, and memory 212.

The ports 203 of an interconnect device 100 may be capable of facilitating the transmission of data packets, or non-packetized data, into, out of, and through the interconnect device 100. Such ports 203 may serve as interface points where network cables may be connected, connecting the interconnect device 100 with other interconnect devices 100, processing devices 103, and/or client devices 109.

Each port 203 may be capable of receiving incoming data packets from other devices and/or transmitting outgoing data packets to other devices. In some implementations, ports 203 may be configured to operate as either dedicated ingress or egress ports 203 or may be enabled to operate in a dual functionality capable of performing ingress and egress functions. For example, an egress port 203 may be used exclusively for sending data from the interconnect device and an ingress port 203 may be used solely for receiving incoming data into the switch.

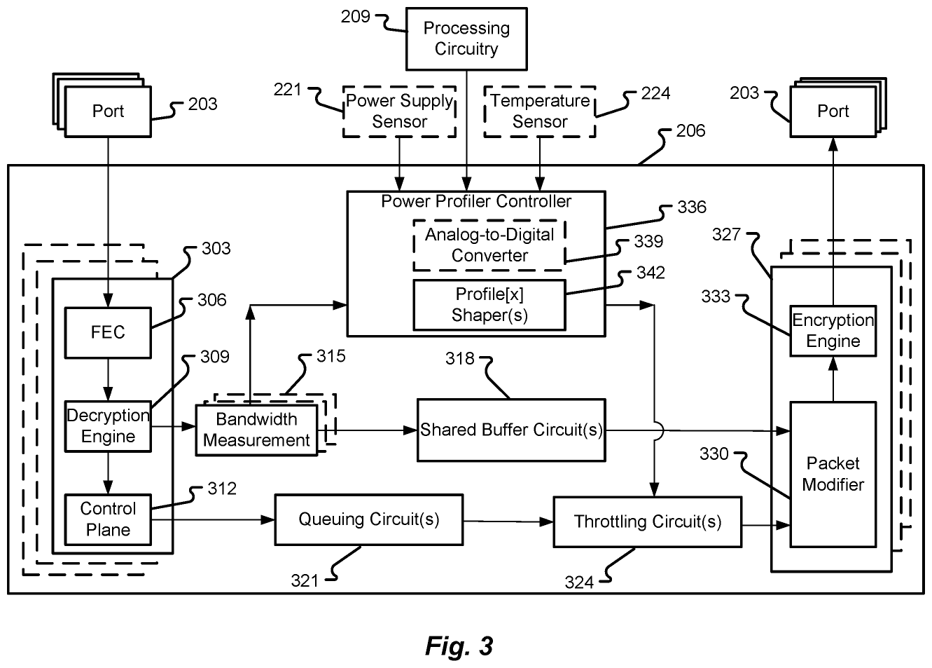

Routing circuitry 206 of an interconnect device 100, as described in greater detail below and in relation to FIG. 3, may be capable of handling a received packet by determining a port from which to send the packet and forwarding the packet from the determined port. Using a system or method as described herein, routing circuitry 206 may be capable of throttling the traversal of data through an interconnect device 100 based on one or more power profiles. As a result, the routing circuitry 206 may be capable of reducing an overall amount of power consumed by the interconnect device 100 without incurring a penalty in processing power.

In support of the functionality of the routing circuitry 206, processing circuitry 209 may be configured to control aspects of the routing circuitry 206 to accomplish throttling in relation to power profiles. The processing circuitry 209 may in some implementations include a CPU, an ASIC, and/or other processing circuitry which may be capable of handling computations, decision-making, and management functions required for operation of the interconnect device 100.

Processing circuitry 209 may be configured to handle level management and control functions of the interconnect device 100, such as setting up routing tables, configuring ports, and otherwise managing operation of the interconnect device 100. Processing circuitry 209 may execute software and/or firmware to configure and manage the interconnect device 100, such as an operating system and management tools. In some implementations, the processing circuitry 209 may be configured to receive power profiles from external devices such as processing devices 103 and/or client devices 109. Processing circuitry 209 may be capable of aggregating multiple received power profiles, updating power profiles based on information such as bandwidth, power consumption, temperatures, etc., as described in greater detail below, and instructing routing circuitry 206 to function in accordance with one or more power profiles.

The processing circuitry 209 may also be capable of storing such power profiles in memory 212 such as in the form of power profile data 215. The processing circuitry 209 may also be capable of correlating bandwidth of the interconnect device 100 with power consumption, temperatures, and/or other factors, and making determinations in response to such correlations. The processing circuitry 209 may store data relating to such correlations in the memory 212 such as in the form of power-bandwidth correlation data 218. Such correlations may be used to adjust one or more power consumption and/or bandwidth thresholds to account for leakage of power.

Memory 212 of an interconnect device 100 as described herein may comprise one or more memory elements capable of storing configuration settings, power profile data 215, power-bandwidth correlation data 218, application data, operating system data, and other data. Such memory elements may include, for example, random access memory (RAM), dynamic RAM (DRAM), flash memory, non-volatile RAM (NVRAM), ternary content-addressable memory (TCAM), static RAM (SRAM), and/or memory elements of other formats.

In some implementations, an interconnect device 100 as described herein may include one or more power supply sensors 221. A power supply sensor 221 may be a current sensor, a voltage sensor, a power meter, or other device capable of being used to monitor power consumption of the interconnect device 100. A current sensor for example may measure flow of electric current (in amperes) from a power supply device 106 to the interconnect device 100. Such a current sensor may be, for example, a Hall-effect current sensor, a current transformer, a shunt resistor, or other type of component capable of being used to determine an amount of current. From the current, the interconnect device 100 may be capable of determining an amount of power consumed at any given time. In some implementations, a current sensor may be used along with a voltage sensor to measure the amount of power consumed. Data from the power supply sensor 221 may be ready by, for example, processing circuitry 209, and may be stored in memory 212.

In some implementations, an interconnect device 100 as described herein may include one or more temperature sensors 224. A temperature sensor 224 may be a thermocouple, a resistance temperature detector, a thermistor, a semiconductor-based sensor, or other device capable of being used to monitor temperature of the interconnect device 100, of an environment in which the interconnect device 100 is operating (ambient temperature), and/or of one or more components of the interconnect device 100 (such as the processing circuitry, an ASIC, or other component). A temperature sensor for example may measure a temperature at any given time. Data from the temperature sensor 224 may be ready by, for example, processing circuitry 209, and may be stored in memory 212.

FIG. 3 illustrates elements of routing circuitry 206 of an interconnect device 100 in accordance with one or more implementations of the present disclosure. One or more ingress ports 203 may, upon receiving data, transmit the data to one or more ingress processing circuits 303. In some implementations, each ingress port 203 may be associated with a dedicated ingress processing circuit 303, while in other implementations, multiple ingress ports 203 may share an ingress processing circuit 303.

Each ingress processing circuit 303 may include one or more of a forward error correction (FEC) circuit 306, a decryption engine circuit 309, a control plane 312, and/or other circuits and components which may handle ingress packets and non-packetized ingress data. An FEC circuit 306 as described herein may be used to perform error detection and correction for packets received from a port 203 before the packets are directed to an egress port. The FEC circuit 306 may receive ingress data from a port 203 and, after performing FEC, output the received ingress data or a processed version of the ingress data to a decryption engine circuit 309.

A decryption engine circuit 309 as described herein may be used to decrypt all or a portion of received packets to enable the interconnect device 100 to determine a port 203 from which to send each packet. The decryption engine circuit 309 may be capable of ensuring that sensitive data remains protected from unauthorized access during traversal of the data through the interconnect device 100. The decryption engine circuit 309 may output received packets or data associated with received packets to one or more shared buffer circuits 318 via a bandwidth measurement component 315 as described below. The decryption engine circuit 309 may also output data associated with received packets to the control plane 312.

A control plane 312 as described herein may be used to manage how received data packets are forwarded and handled within the interconnect device 100. The control plane 312 may receive data associated with a received packet from the decryption engine circuit 309 and, based on the data associated with received packet, write instructions to one or more queueing circuits 321 as described below.

Each of the FEC circuit 306, decryption engine circuit 309, control plane 312, and/or other circuits and components of the ingress processing circuits 303 may include one or more of an ASIC, FPGA, digital signal processor (DSP), network processor, accelerator, hardware secure module, CPU, and/or other components and circuits capable of performing ingress processing. As should be appreciated, each ingress processing circuit 303 of an interconnect device 100 may include one or more additional circuits and components in addition to or instead of the FEC circuit 306, decryption engine circuit 309, and control plane 312 described above.

Each of the ingress processing circuits 303 of the interconnect device 100 may be enabled to write data to a shared-buffer circuit 318 and a queueing circuit 321. Packets to be egressed from the interconnect device 100 may be stored in a shared-buffer circuit 318. Data which may be used by egress processing circuits 327 to route packets to egress ports 203 may be written to the queuing circuits 321. Once the queueing circuit 321 assigns a particular packet to a particular egress port 203, packet data stored in the shared buffer circuit 318 may be read by an egress processing circuit 327 associated with the particular egress port 203.

Data to be sent from the interconnect device 100 may be processed by one or more egress processing circuits 327. In some implementations, each port 203 which is used for egress may be associated with a dedicated egress processing circuit 327. In other implementations, multiple egress ports 203 may share one or more egress processing circuits 327.

An egress processing circuit 327 may include, but should not be considered as limited to, a packet modifier 330 and an encryption engine 333. A packet modifier 330 as described herein may include circuitry such as an ASIC, an FPGA, or other componentry capable of adjusting packets before the packets are transmitted from the interconnect device. Such adjustments may include, for example, the adding or removal of tags, modification of settings and packet header data, and other modifications. An encryption engine 333 as described herein may include circuitry such as an ASIC, an FPGA, or other componentry capable of encrypting packets before the packets are transmitted from the interconnect device. Such encryption may include, for example, use of encryption algorithms such as Advanced Encryption Standard (AES), RSA, or other algorithms.

After being processed by an egress processing circuit 327, a packet may be transmitted from the interconnect device 100 via an egress port 203. The egress port 203 may be directly connected to an ultimate destination of the packet or may be connected to another interconnect device 100 which may forward the packet towards the ultimate destination.

As described above, routing circuitry 206 of an interconnect device 100 may be capable of throttling the traversal of data through the interconnect device 100 based on one or more power profiles. As a result, the routing circuitry 206 may be capable of reducing an overall amount of power consumed by the interconnect device 100 without incurring a penalty in processing power.

The reduction of the overall power consumption of the interconnect device 100 may be achieved through the use of one or more power profiler controllers 336. A power profiler controller 336 may be one or more of, or a combination of, ASICs, FPGAs, and other componentry capable of performing the functions of the power profiler controller 336 as described herein.

A power profiler controller 336 may be capable of measuring bandwidth, such as through the use of a bandwidth measurement component 315 as described below, and throttling data traversing the interconnect device 100, such as through the use of one or more throttling circuits 324 as described below. A power profiler controller 336 may include or be in communication with an analog-to-digital converter (ADC) 339 and one or more profile shapers 342.

An ADC 339 of a power profiler controller 336 of an interconnect device 100 may include one or more of a delta-sigma ADC, a flash ADS, a successive approximation register ADC, or other device capable of receiving analog data from a power supply sensor 221, such as a current sensor, a temperature sensor 348, or other source, and converting the analog data to digital to be interpreted by the power profiler controller 336.

A power supply sensor 221 may be used by the power profiler controller 336 to determine an amount of power or current consumed by the interconnect 100 at any given time. In some implementations, the power profiler controller 336 may use a current reading to determine a number of watts consumed by the interconnect device 100.

The interconnect device 100, using a profile shaper 342, may be enabled to govern or regulate power consumption based on one or more power profiles. In some implementations, power profiles may be provided to the power profiler controller 336 by processing circuitry 209 of the interconnect device 100. For example, in some implementations, a user may be enabled to set one or more power consumption limits or thresholds and/or bandwidth limits or thresholds. Users may, such as by interacting with client devices 109 and/or processing devices 103, be enabled to set such power consumption limits or thresholds and/or bandwidth limits or thresholds manually or such power consumption limits or thresholds and/or bandwidth limits or thresholds may be set automatically by client devices 109 and/or processing devices 103. In some implementations, in addition to or instead of user-defined thresholds, thresholds may be automatically set based on various performance demands. For example, thresholds may be defined by one or more optimization algorithms and/or artificial intelligence models which may be capable of monitoring bandwidth and/or power consumption and dynamically adjusting threshold amounts and/or threshold durations.

A profile shaper 342 may be configured to control or manage bandwidth of data traversing the interconnect device 100. For example, a profile shaper 342 may control one or more throttling circuits 324 of the interconnect device 100. Controlling a throttling circuit 324 may involve switching the throttling on and off or adjusting an amount of throttling. Amounts of throttling may be dependent on various thresholds and thresholds may be dependent on power profiles in effect as described herein.

The power profiler controller 336 may in some implementations include a plurality of profile shapers 342. In some implementations a profile shaper 342 may be associated with a particular power profile and/or a particular threshold bandwidth. For example, one power profile may be associated with multiple thresholds and each threshold may be associated with a respective profile shaper 342.

The power profiler controller 336 may be enabled to measure the bandwidth traversing the interconnect device 100. While the routing circuitry 206 illustrated in FIG. 3 includes a bandwidth measurement component 315 between the decryption engine and the shared buffer circuit 318, it should be appreciated that the bandwidth measurement component 315 may be in other positions within or outside of the routing circuitry 206 and that the power profiler controller 336 may be enabled to measure bandwidth at various points along the path from the ingress port 203 to the egress port 203. For example, the bandwidth measurement component 315 may be capable of measuring ingress bandwidth and/or egress bandwidth.

Using the bandwidth measurement component 315, the power profiler controller 336 may be enabled to measure an amount of bandwidth per ingress port 203. In some implementations, each ingress port 203 or ingress processing circuitry 303 may be enabled to report its respective bandwidth to the power profiler controller 336. The power profiler controller 336 may be enabled to aggregate the bandwidths of each port 203 together to understand the overall bandwidth currently required by the ingress ports 203. In this way, the power profiler controller 336 may be enabled to monitor, in real-time, the bandwidth that traverses the switch at every given minute.

In some implementations, the bandwidth measurement component 315 may additionally or alternatively be enabled to be used by the power profiler controller 336 to measure an amount of bandwidth per egress port 203. For example, each egress port 203 or egress processing circuitry 327 may be enabled to report its respective egress bandwidth to the power profiler controller 336. The power profiler controller 336 may be enabled to aggregate the egress bandwidths of each port 203 to understand the overall egress bandwidth of the interconnect device 100.

Each profile shaper 342 may be configured to a particular threshold and can cause throttling, if necessary, as described below. The throttling circuits 324 may be enabled to cause scheduling of packets to the egress processing circuitry 327 to cease or to occur at a lesser rate. For example, when a bandwidth measured by a bandwidth measurement component 315 meets or exceeds a threshold according to a power profile, a profile shaper 342 may control throttling circuits 324 to stop traffic from being egressed.

In some implementations, the throttling circuits 324 may be enabled to throttle traffic on the ingress side and/or the egress side of the routing circuitry 206. Whether the throttling is performed on the egress side or the ingress side or both may depend on factors such as whether the traffic is lossy or lossless. In some implementations, a throttling circuit 324 may throttle traffic at the egress side for a period of time until the shared buffer circuit(s) 318 reach a maximum or a threshold storage level then the throttling circuit 324 may throttle traffic at the ingress side to prevent the loss of packets for a lossless system.

The thresholds in effect may change over time according to any power profiles in effect as described below. At various time windows according to a power profile, the power profiler controller 336 may be enabled to load a profile shaper 342 with a value corresponding to a specific threshold. For example, power profiles may include a plurality of different thresholds which may be in effect at various times over the course of one or more intervals.

In some implementations, using data from a temperature sensor 224, the power profiler controller 336 may be enabled to monitor a temperature and adjust power profile thresholds based on the temperature. Because temperatures affect leakage, and leakage results in excessive power consumption, by adjusting power profile thresholds based on temperature, the power profiler controller may be enabled to take into consideration ASIC temperature, power leakage, and/or other considerations when applying a particular power profile.

For example, if the temperature as measured by a temperature sensor 224 is higher than a normal operating temperature or above average, it can be assumed that leakage is higher and that power consumption per bandwidth is higher than normal or average. As a result, the threshold can be adjusted lower to account for the leakage.

In some implementations, the power profiler controller 336 may be configured to respond to data in packets received by the interconnect device 100. For example, the power profiler controller 336 may be capable of determining a packet traversing the interconnect device 100 contains data indicating a congestion state. Such data may include an explicit congestion notification (ECN), a forward ENC (FECN), and/or a congestion notification packet (CNP). When an interconnect device 100 receives a packet marked as an ECN, an FECN, a CNP, or some other congestion marker, the interconnect device 100 may be likely to receive less traffic due to the congestion. As a result, the interconnect device 100, through implementing a system or method as described herein, may be enabled to reduce power consumption by applying a particular power profile and/or threshold to lower the power consumption in anticipation of sustained relatively low bandwidth. In such an implementation, the power profiler controller 336 may be configured to apply a low-bandwidth power profile in the event that one or more packets are received indicating congestion.

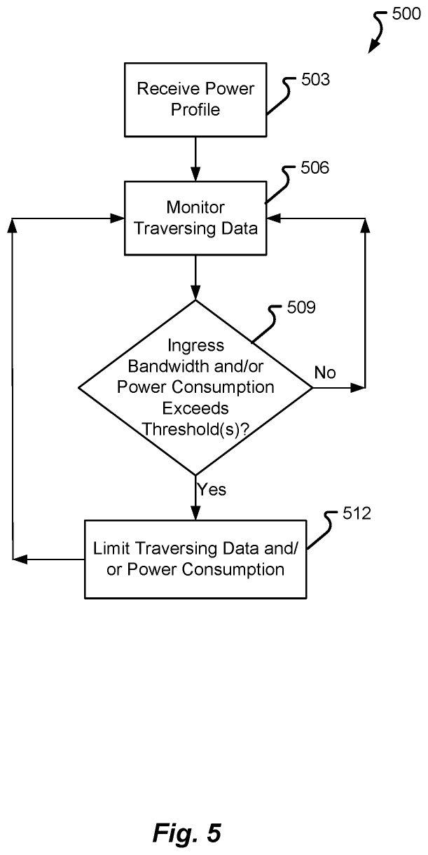

Adjusting thresholds may comprise configuring a hardware circuit such as a profile shaper 342 and/or a throttling circuit 324 to be enabled to throttle traffic at the adjusted threshold as described below in relation to FIG. 5. The throttling circuits 324 of the interconnect device 100 may be enabled to throttle traffic traversing the interconnect device 100 in various ways. In some implementations, the manner in which traffic is throttled may depend at least in part on whether the traffic is lossless or lossy.

For example, for lossless data, the interconnect device 100 may be required to avoid dropping packets. In such a system, when the profile shaper 342 initiates throttling, incoming packets may be aggregated into the shared buffer circuit 318. When this occurs, a credit back pressure may take place and congestion in the interconnect device 100 may cause traffic to be throttled backwards. Eventually, source(s) of the traffic may stop sending packets to the interconnect device 100 and/or latency may occur.

For lossy data, the interconnect device 100 may be capable of dropping packets. If a profile shaper 342 initiates throttling, some packets may be held in the shared buffer (e.g., microseconds of traffic) while other packets received at the ingress side may be dropped. In some implementations, through an adaptive routing mechanism an early congestion notification may be sent to source.

The power profiler controller 336 may be enabled to receive instructions from, and send data to, processing circuitry 209 of the interconnect device 100, as well as to read data from a power supply sensor 221, a temperature sensor 224, and/or other components. The thresholds for throttling by the profile shaper(s) 342 may be based on such power profiles as may be provided to the power profiler controller 336 by, for example, processing circuitry 209.

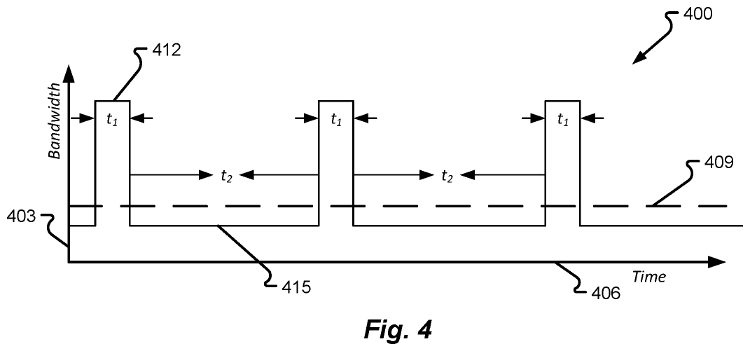

An example power profile 400 as may be implemented by a power profiler controller 336 is illustrated in FIG. 4. To illustrate the example power profile 400, bandwidth is plotted on a vertical axis 403 and time is plotted on a horizontal axis 406. The overall average bandwidth is illustrated by a dashed line 409.

In the example power profile 400, a high bandwidth phase 412 for a time t₁ is followed by a low bandwidth phase 415 for a time t₂. During the high bandwidth phase 412, a first threshold bandwidth may be applied by a profile shaper 342. During a time period of t₁, the profile shaper 342 may initiate throttling only when bandwidth exceeds the first threshold. This high bandwidth phase 412 may represent a period of relatively intense activity of the interconnect device 100, such as during periods when processing devices 103, as described above, are relatively less active in processing data and are requiring interaction with other devices.

During the low bandwidth phase 415, a second threshold bandwidth may be applied by the same or a different profile shaper 342. During a time period of t₂, the profile shaper 342 may initiate throttling when bandwidth exceeds the second threshold. This low bandwidth phase 415 may represent a period of relatively calm activity of the interconnect device 100, such as during periods when processing devices 103, as described above, are relatively more active in processing data and are requiring less interaction with other devices.

While shown as an immediate switch between the high bandwidth phase 412 and the low bandwidth phase 415, it should be appreciated that in some implementations a transition period between the phases 412, 415 may be used to ramp up or down the thresholds.

In the example power profile 400 of FIG. 4, the high bandwidth phase 412 is of a lesser duration than the low bandwidth phase 415. It should be appreciated that these durations may change depending on application requirements. For example, in some implementations, high bandwidth phases 412 may be of greater duration than the low bandwidth phases 415 or of the same duration. Example durations may be, for example, 50 milliseconds followed by 950 milliseconds, for a total repetition time of one second. Though it should be appreciated that other amounts of time may be used. Example thresholds may be, for example, 90% of a maximum bandwidth for a high threshold and 20% of the maximum bandwidth for a low threshold. As another example, a high bandwidth threshold may be 26 terabits per second (Tbps) followed by 5.6 Tbps for a low bandwidth threshold. As another example, a high bandwidth threshold may be 100% of a maximum bandwidth and a low bandwidth threshold may be zero percent of the bandwidth allowed. Also, while only two levels, high and low, are illustrated, in some implementations more levels may be used. In some implementations a power profile may include any number of one or more thresholds. As an example, a power profile may include four thresholds. A first threshold may be a low-bandwidth threshold, a second threshold may be a mid-bandwidth threshold, a third threshold may be a high-bandwidth threshold, and a fourth threshold may be a maximum bandwidth threshold. Also, each threshold may be associated with the same or a different amount of time. For example, a first threshold may be of a first duration, a second threshold may be of a second duration, a third threshold may be of a third duration, and a fourth threshold may be of a fourth duration. Each of the first through fourth durations may be any amount of time, whether equal to other durations or different from each of the other durations. As should be appreciated, power profiling as described herein should not be considered limited to the use of two thresholds. Also, in some implementations, instead of square shaped curves, a power profile may comprise smooth functions.

In the example illustrated in FIG. 4, the power profile 400 has two phases 412, 415. During the high bandwidth phase 412, the interconnect device 100 may be used by one or more processing devices 103 to perform high levels of communication while during the low bandwidth phase 415, the interconnect device 100 may be used by one or more processing devices 103 for sporadic communication.

Power profiles, such as the power profile 400 illustrated in FIG. 4, may be created by users such as users of client devices 109 or may be created automatically by applications executed by client devices 109 and/or processing devices 103. For example, a user or application may be enabled to chart one or more applicable power-profile(s) that are applicable to one or more specific application(s). Such power profiles may include one or more windows of high bandwidth thresholds and one or more windows of low bandwidth thresholds. Through the creation of particular power profiles, any desired average power-envelope for an interconnect device 100 can be achieved.

As packets are processed by ingress processing circuitry 303 and egress processing circuitry 327, power is consumed by components such as FEC circuit(s) 306, decryption engine circuit(s) 309, control plane(s) 312, packet modifier(s) 330, and encryption engine(s) 333. When higher amounts of bandwidth are traversing an interconnect device 100, the interconnect device 100 may consume greater amounts of power as compared to when lower amounts of bandwidth are traversing the interconnect device 100. The amount of power consumed by an interconnect device 100 may be in direct correlation with the amount of bandwidth traversing the interconnect device 100. As a result, the power profile for an application can be used to configure an overall average amount of power consumed by the interconnect device 100 and the power profile which can inform the interconnect device 100 what overall average power consumption should be expected. The windows of high and low bandwidth may correlate directly to windows of high and low power consumption.

While the power profile illustrated in FIG. 4 is in terms of bandwidth over time, it should be appreciated that in some implementations a power profile may be in terms of power over time. That is, a power profile may indicate two or more threshold amounts of power as opposed to threshold amounts of bandwidth. If power consumed by the interconnect device 100 exceeds a threshold amount of power, throttling of data traversing the interconnect device 100 may occur to result in less data traversing the interconnect device 100 and, as a result, less power consumed by the interconnect device 100.

As illustrated in FIG. 5, an example method 500 may be implemented by an interconnect device 100 as described herein to enable power consumption control based on one or more power profiles. As described above, an interconnect device 100 may be, for example, a switch or other type of computing system capable of receiving and forwarding data in a network. The interconnect device 100 may be utilized by one or more processing devices 103 and/or client devices 109 to provide interconnect services with one or more other processing devices 103 and/or client devices 109. The interconnect device 100 may receive power from one or more power supply devices 106. Such power supply devices 106 may be comprised by the interconnect device 100 or may be shared by a plurality of interconnect devices 100, processing devices 103, and/or client devices 109.

At 503, the interconnect device 100 may receive a power profile. The power profile may be received from an application executing on a processing device, may be programmed by a system administrator or other user, or otherwise may be stored in memory 212 of an interconnect device 100 as power profile data 215.

For example, a user of a client device 109 may design an application which may utilize the processing devices 103 to perform a computationally intensive task. The task may require processing devices 103 to perform processing functions and to interact with other processing devices 103 and/or client devices 109 via one or more interconnect devices 100. The user may specify an amount of time (e.g., a number of milliseconds) during which high bandwidth may be allowed to traverse interconnect devices and an amount of time (e.g., a number of milliseconds) between such periods of high bandwidth time during which lower levels of bandwidth may be allowed to traverse the interconnect devices. The user may also specify an amount of bandwidth or power which may be allowed during each of the high and low bandwidth periods of time. For example, the user may specify a percentage of a maximum bandwidth, a data rate, or a power level which may be used by the interconnect device to determine the thresholds to put into effect when implementing the power profiles as described herein.

In some implementations, a power profile may be applied to a plurality of interconnect devices 100 in a network. For example, an overarching or governing power profile may be implemented such that each of (or a subset of) the interconnect devices 100 in a network executes the same or similar power profiles. In some such implementations the interconnect devices 100 may operate in sync with each other to provide interconnect services for processing devices 103 and/or client devices 109 in accordance with a common power profile.

A power profile as described herein may specify two or more time periods. Each time period may be associated with a particular threshold. Each threshold may be a power threshold or a bandwidth threshold. In some implementations, receiving a power profile may comprise receiving an interval time (e.g., 1 second), a pulse length (e.g., 50 milliseconds) representing a high bandwidth (or power) pulse, a first (or high) threshold amount, and a second (or low) threshold amount. It should be appreciated that any of the numbers provided herein with regard to durations and thresholds are provided for example purposes only and should not be considered as limiting in any way.

A power profile may be one of a plurality of power profiles. For example, the interconnect device 100 may receive a plurality of power profiles from one or more processing devices 103 and/or client devices 109. In some implementations, each of the plurality of power profiles may be associated with a respective application, a respective service, respective flow, a respective destination device, or a respective source device. In other implementations, each power profile may be unassociated with any particular application, service, flow, or device.

In some implementations, the interconnect device 100 may be enabled to aggregate a plurality of received power profiles. In such implementations, the interconnect device 100 may determine the thresholds to be applied based on the aggregated plurality of power profiles. For example, the interconnect device 100 may using a summing operation to calculate a total of high and/or low thresholds, calculate an average of high and/or low thresholds, select a maximum and/or a minimum of high and/or low thresholds, or otherwise create an aggregated power profile based on received thresholds.

At 506, the interconnect device may monitor one or more of an ingress bandwidth and power consumption. Monitoring ingress bandwidth as described herein may involve measuring the rate at which data packets enter the interconnect device 100 via one or more ingress ports 203. In some implementations, the bandwidth may be measured on a per-port basis and the per-port bandwidth measurements may be aggregated to reach a total ingress bandwidth. As illustrated in FIG. 3, in some implementations, the bandwidth measurement may take place at a point between the ingress processing circuit 303 and the shared buffer circuit 318. For example, packets may be sent from a decryption engine circuit 309 of the ingress processing circuit 303 associated with a particular port to the shared buffer circuit 318. A bandwidth measurement component 315 may be used by a power profiler controller 336 to track the bandwidth. It should be appreciated, however, that the bandwidth measurement may occur at other places along the patch which data takes as it traverses the interconnect device 100.

The monitoring of bandwidth may be accomplished through sampling data flow at one or more points in the interconnect device 100 at regular intervals (e.g., every millisecond), tracking a real-time bandwidth for each ingress port 203, using statistical sampling or any other method for determining or estimating a rate of data traversing the interconnect device 100.

Monitoring power consumption as described herein may involve a power profiler controller 336 reading data from a power supply sensor 221 as described above. For example, a power supply sensor 221 may be a current sensor, a voltage sensor, a power meter, or other device, and may be used to determine a current amount of amperage drawn by the interconnect device 100 at any given time. Similar to measuring bandwidth as described above, a power supply sensor 221 may be read at intervals or in real time. In some implementations, the power profiler controller 336 may be configured to determine a moving average power consumption or may simply monitor the actual power consumption over time.

In some implementations, determining a moving average of power consumption may involve calculating an average power usage over a specific period or window of time. The window of time may be microseconds, milliseconds, seconds, minutes, or even longer depending on configuration settings. The power supply sensor 221 may be used to gather continuous or periodic readings of power consumption. Next, the power consumption readings may be added and divided based on the window of time to compute the average. The moving average may be recalculated regularly, such as every time a new data point is added by the power supply sensor 221.

While the systems and methods described herein are described as including monitoring bandwidth and/or power consumption, it should be appreciated that in some implementations other resources may, in addition or instead of bandwidth and power consumption, be monitored. Such resources may include, for example, packet-rates, buffer utilization, queue length, and/or any other type of resource which may be monitored in a device. The systems and methods described herein regarding using monitored bandwidths and/or power consumptions may be performed in such a way as to include monitoring any other such resources instead of or in addition to bandwidth and/or power consumption.

In some implementations, the power profiler controller 336, or processing circuitry 209, may be enabled to correlate power consumption with bandwidth. As described above, because the processing of any given packet traversing the interconnect device 100 consumes power, the power consumption of the interconnect device can be used to determine or estimate a current bandwidth of data currently traversing the interconnect device 100. In some implementations, the power-to-bandwidth correlation may be configuration settings written to the interconnect device 100 by another device, such as a client device 109. Power-to-bandwidth correlation data 218 may be stored in memory 212 of the interconnect device 100. In some implementations, the interconnect device 100 may update the power-to-bandwidth correlation data 218 over time as more data, e.g., power consumption readings and bandwidth measurements, is collected by the interconnect device 100 to account for power leakage.

Using the power-to-bandwidth correlation data 218, the interconnect device may be enabled to translate bandwidth thresholds to power thresholds and vice-versa. For example, a power-to-bandwidth correlation data 218 may be a linear function, where power and bandwidth are in a positive correlation or a direct correlation. As power consumption of the interconnect device 100 increases, the bandwidth of data traversing the interconnect device 100 increases at the same rate or in a linear relationship with the power consumption. As should be appreciated, in some implementations, bandwidth may be in an exponential or other type of predictable relationship with power consumption.

At 509, the power profiler controller 336 may determine whether ingress bandwidth exceeds a bandwidth threshold and/or power consumption of the interconnect device 100 exceeds a power threshold. The bandwidth threshold and/or power threshold compared to the current bandwidth and/or power consumption measurements may be based on a power profile currently in effect. For example, the power profiler controller 336 may alternate between two or more thresholds over time based on a power profile. In some implementations, alternating between thresholds may comprise switching between different profile shapers 342. For example, a first profile shaper 342 may be configured to throttle traffic over a first threshold while a second profile shaper 342 may be configured to throttle traffic over a second threshold. The power profiler controller 336 may be enabled to switch the profile shaper 342 in effect over time based on a power profile.

In some implementations, a power threshold may be set as a percentage of a maximum power consumption. The maximum power consumption may be a physical limit or may be a level set by a consumer or other user of the interconnect device 100.

In some implementations, different power profiles and/or thresholds may be applied to different queues. For example, a first power profile may be applied to queues designated as high priority and may allow for relatively greater amounts of bandwidth and/or power consumption by such queues, while a second power profile may be applied to queues designated as low priority and may allow for relatively less bandwidth and/or power consumption by such low priority queues. As should be appreciated, different power profiles may be in effect at any given time in an interconnect device 100 and each power profile may be applied to one or more particular queues to provide for greater system flexibility and to reduce overall power consumption without affecting all flows and/or all queues traversing the interconnect device 100.

Also, in some implementations, different power profiles may be in effect for different applications which utilize the interconnect device 100. For example, one or more processing devices 103 may execute multiple applications which involve transmitting data via an interconnect device 100. Each such application may be associated with a particular power profile. The interconnect device 100 may be enabled to implement each power profile associated with each application simultaneously such that the interconnect device 100 is capable of providing the required bandwidth and/or power consumption for each application as needed.

At 512, if the ingress bandwidth exceeds a bandwidth threshold and/or power consumption exceeds a power threshold, the power profiler controller 336, using the profile shaper 342, may limit data traversing the interconnect device 100 and, in effect, the power consumption of the interconnect device 100.

For example, during a first time period indicated by a power profile, the profile shaper 342 may, upon determining ingress bandwidth or power consumption exceeds a threshold, limit egress processing of packets. Limiting egress processing of packets may in some implementations involve storing ingress packets in a shared buffer but delaying the scheduling of sending the packets. It should be appreciated however that other methods of limiting egress processing of packets may be implemented. In some implementations, limiting egress processing may comprise ceasing the egress of packets while in other implementations, limiting egress processing may comprise capping an egress bandwidth at a limited rate. In some implementations, limiting the egress of packets may comprise throttling traffic or dropping packets.

As bandwidth and/or power consumption of an interconnect device 100 is throttled based on a particular power profile, the power consumed by the interconnect device 100 may be limited. As a result, for an interconnect device 100 which shares a power supply 106 with one or more processing devices 103, as illustrated in FIG. 1, power may be shifted from the interconnect device 100 to the processing devices 103. As the power profile of the interconnect device 100 allows for greater power consumption by the interconnect device 100, power consumption of the processing devices 103 may be expected to decline as the processing devices 103 wait for information from the interconnect devices 100. During such time, power supplied by the power supply device(s) 106 to the processing devices 103 may shift to the interconnect devices 100. In some implementations, power supply devices 106 may be controlled by a controller device or by an interconnect device 100 to synchronize the power supplied to the interconnect device 100 with one or more power profiles enforced by the interconnect device 100.

In some implementations, when an interconnect device 100 receives power from a power supply device 106 shared by one or more other interconnect devices 100 and/or processing devices 103, power consumption thresholds of the interconnect device 100 may be associated with an amount of power consumed by the interconnect device 100 from the power supply 106. Power profiling performed by an interconnect device 100 may be on a per-power rail basis. If an interconnect device 100 includes two or more power rails, the power profiling system of the interconnect device 100 may take the additional power rails into account such as by adjusting an amount of power consumed from each rail separately.

While description provided herein refers to limiting the egress of packets, it should be appreciated that bandwidth of data traversing the interconnect device 100 may be limited at any point in the interconnect device 100, whether in the ingress circuitry, the egress circuitry, or at points between ingress and egress.

At the end of the first time period, the power profiler controller 336 may change the threshold in effect based on the power profile in effect. Changing the threshold may include switching the profile shaper 342 to a different profile shaper 342, where each profile shaper 342 is configured based on a particular bandwidth or power threshold, or changing the threshold may include instructing the profile shaper 342 to change the threshold. In some implementations, a single profile shaper 342 may be capable of enforcing various thresholds. For example, a profile shaper 342 may be capable of limiting traversing data using any one or more of a plurality of different thresholds.

To provide additional illustration of the method 500 described above in relation to FIG. 5, consider an interconnect device 100 which receives a power profile. The example power profile includes an interval time of one second and a high bandwidth phase of fifty milliseconds. Following the power profile, the interconnect device 100 will compare ingress bandwidth to a high bandwidth threshold for a first fifty milliseconds of the one second interval time and to a low bandwidth threshold for the remaining 950 milliseconds of the one second interval time. The example power profile includes data indicating a high bandwidth threshold of 26 Tbps and a low bandwidth threshold of 5.6 Tbps.

Upon receiving the power profile, the interconnect device 100 may, using a clock or a clock signal, apply the high bandwidth threshold for the first fifty milliseconds of the one second interval time and apply the low bandwidth threshold for the remaining 950 milliseconds of the one second interval time. The interconnect device 100 may monitor the ingress bandwidth and compare the ingress bandwidth to either the high bandwidth threshold or the low bandwidth threshold based on the clock. If the monitored ingress bandwidth exceeds the effective threshold, the egress bandwidth may be throttled to reduce or maintain power consumption of the interconnect device 100.

As an example of a power profile which indicates a power threshold as opposed to a bandwidth threshold, consider an interconnect device 100 which receives a power profile including an interval time of one second and a high-power consumption phase of fifty milliseconds. Following the power profile, the interconnect device 100 will compare power consumption to a high-power consumption threshold for a first fifty milliseconds of the one second interval time and to a low power consumption threshold for the remaining 950 milliseconds of the one second interval time. The example power profile includes data indicating a high-power consumption threshold of 26 Watts and a low bandwidth threshold of 5.6 Watts.

Upon receiving the power profile, the interconnect device 100 may, using a clock or a clock signal, apply the high-power consumption threshold for the first fifty milliseconds of the one second interval time and apply the low power consumption threshold for the remaining 950 milliseconds of the one second interval time. The interconnect device 100 may monitor the power consumption and compare the power consumption to either the high-power consumption threshold or the low power consumption threshold based on the clock. If the monitored power consumption exceeds the effective threshold, the egress bandwidth may be throttled to reduce or maintain power consumption of the interconnect device 100.

In some implementations, an interconnect device 100 may be enabled to convert a power consumption threshold to a bandwidth threshold or convert monitored ingress bandwidth to a power consumption estimate. For example, as described above, an interconnect may be capable of correlating power consumption to bandwidth. In some implementations, the interconnect device 100 may store a lookup table with power-to-bandwidth correlation data. The interconnect device may be capable of translating a bandwidth threshold to a power consumption threshold, or of converting measurements of bandwidth to estimates of power consumption.

In some implementations, an interconnect device 100 as described herein may be capable of updating thresholds of a power profile over time using a control loop. While power-consumption-to-bandwidth ratios may be expected to be on a directly related basis, certain circumstances can affect the ratio. For example, atmospheric temperatures may cause higher power consumption at lower bandwidths. By measuring actual power consumption, e.g., through the use of a current sensor, an interconnect device may be capable of compensating a particular power profile to account for the change in temperature. For example, an interconnect device 100 may either raise or lower thresholds for a given power profile upon detecting higher temperatures. Other factors may also affect the power-to-bandwidth ratio, such as packet size. In some scenarios, larger packets may reduce the power-to-bandwidth ratio while smaller packets may increase the power-to-bandwidth ratio, as larger packets may reduce the amount of ingress and/or egress processing required for a given number of bits traversing the interconnect device. To compensate for any such factors, a feedback loop may be implemented where the interconnect device may measure actual power consumption and update a power profile over time to be more accurate.

The present disclosure encompasses methods with fewer than all of the steps identified in FIG. 5 (and the corresponding description of the method 500), as well as methods that include additional steps beyond those identified in FIG. 5 (and the corresponding description of the method 500). The present disclosure also encompasses methods that comprise one or more steps from the methods described herein, and one or more steps from any other method described herein.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art. It is to be appreciated that any feature described herein can be claimed in combination with any other feature(s) as described herein, regardless of whether the features come from the same described embodiment.

What is claimed is:

1. A system comprising one or more circuits to:
receive a power profile;
monitor one or more of data traversing the system and power consumption of the system; and
during a first time period:
determine at least one of an ingress bandwidth exceeds a first bandwidth threshold and the power consumption exceeds a first power threshold, wherein at least one of the first bandwidth threshold and the first power threshold is defined in the power profile; and
in response to determining the at least one of the ingress bandwidth exceeds the first bandwidth threshold and the power consumption exceeds the first power threshold, limit one or more of the data traversing the system and the power consumption of the system.

2. The system of claim 1, wherein monitoring the data traversing the system comprises monitoring one or more of a bandwidth, a packet rate, a buffer utilization, and a queue length.

3. The system of claim 1, wherein the one or more circuits are further to correlate the monitored data traversing the system with the power consumption of the system and to adjust one or more of the first power threshold and the first bandwidth threshold based on the correlation to account for leakage of power.

4. The system of claim 1, wherein the one or more circuits are further to update one or more of the first power threshold and the first bandwidth threshold based on a correlation of the monitored data traversing the system with the power consumption of the system.

5. The system of claim 1, wherein limiting the one or more of the data traversing the system and the power consumption of the system comprises limiting one or more of an ingress bandwidth and an egress bandwidth.

6. The system of claim 1, wherein the first power threshold indicates a user-defined power consumption limit.

7. The system of claim 6, wherein the system receives power from a power supply shared by one or more interconnect devices and processing devices, wherein the power consumption limit is associated with an amount of power consumed by the system from the power supply.

8. The system of claim 1, wherein the first bandwidth threshold indicates a user-defined bandwidth limit.

9. The system of claim 8, wherein the one or more circuits are further to determine a power requirement based on the bandwidth limit.

10. The system of claim 1, wherein the one or more circuits are further to measure one or more of a current and a voltage and calculate a moving average power consumption.

11. The system of claim 1, wherein the one or more circuits are further to, during a second time period,
determine at least one of the ingress bandwidth exceeds a second bandwidth threshold and the power consumption exceeds a second power threshold, wherein at least one of the second bandwidth threshold and the second power threshold is defined in the power profile; and
in response to determining the at least one of the ingress bandwidth exceeds the second bandwidth threshold and the power consumption exceeds the second power threshold, limit egress of packets.

12. The system of claim 11, wherein at least one of the first bandwidth threshold is greater than the second bandwidth threshold and the at least one of the first power threshold is greater than the second power threshold.

13. The system of claim 11, wherein the first time period is of a lesser duration than the second time period.

14. The system of claim 11, wherein a shaper circuit determines the at least one of the ingress bandwidth exceeds the first bandwidth threshold and the power consumption exceeds the first power threshold and determines the at least one of the ingress bandwidth exceeds the second bandwidth threshold and the power consumption exceeds the second power threshold.

15. The system of claim 1, wherein limiting egress of packets comprises one or more of throttling traffic and dropping packets.

16. The system of claim 1, wherein the power profile specifies two or more time periods, wherein the first time period is associated with one or more of the first bandwidth threshold and the first power threshold and a second time period is associated with one or more of a second bandwidth threshold and a second power threshold.

17. The system of claim 1, wherein the one or more circuits are further to monitor a temperature and adjust one or more of the first bandwidth threshold and the first power threshold based on the temperature.

18. The system of claim 1, wherein the power profile is one of a plurality of power profiles and each of the plurality of power profiles is associated with a respective application, wherein the one or more circuits are further to aggregate the plurality of power profiles and determine one or more of the first bandwidth threshold and the first power threshold based on the aggregated plurality of power profiles.

19. A method comprising:
receiving a power profile;
monitoring one or more of data traversing a system and power consumption of the system; and
during a first time period:
determining at least one of an ingress bandwidth exceeds a first bandwidth threshold and the power consumption exceeds a first power threshold, wherein at least one of the first bandwidth threshold and the first power threshold is defined in the power profile; and
in response to determining the at least one of the ingress bandwidth exceeds the first bandwidth threshold and the power consumption exceeds the first power threshold, limiting one or more of the data traversing the system and the power consumption of the system.

20. A switch comprising:
one or more ports; and
a power profile controller to:
receive a power profile;
monitor one or more of data traversing the switch and power consumption of the switch; and
during a first time period:
determine at least one of an ingress bandwidth exceeds a first bandwidth threshold and the power consumption exceeds a first power threshold, wherein at least one of the first bandwidth threshold and the first power threshold is defined in the power profile; and
in response to determining the at least one of the ingress bandwidth exceeds the first bandwidth threshold and the power consumption exceeds the first power threshold, limit one or more of the data traversing the switch and the power consumption of the switch.
